(19) United States
(12) Patent Application Publication
(10) Pub. No.: US 2022/0060975 A1
(43) Pub. Date: Feb. 24, 2022

(54) IDENTIFICATION OF ACCESS POINT INFORMATION

(71) Applicant: Hewlett-Packard Development Company, L.P., Spring, TX (US)

(72) Inventors: Hsuan-Chieh Li, Taipei City (TW); Shu-min Chang, Taipei City (TW); Chun-Feng Li, Taipei City (TW); Tomax Tai, Taipei City (TW)

(73) Assignee: Hewlett-Packard Development Company, L.P., Spring, TX (US)

(21) Appl. No.: 17/419,431

(22) PCT Filed: Feb. 22, 2019
(86) PCT No.: PCT/US2019/019275

§ 371 Date: Jun. 29, 2021

(51) Int. Cl. H04W 48/16; H04W 88/08; H04W 8/26

(52) U.S. Cl. CPC H04W 48/16; H04W 8/26; H04W 88/08

(57) ABSTRACT

Techniques to identify information associated with an Access Point (AP) are described. The information associated with an AP corresponding to AP Parameters (APP) is received from a user. Based on the information associated with the AP, a unique ID corresponding to the AP is generated. An AP information ID (APID) is generated by combining the unique ID with the SSID. The generated APID is provided to the AP for broadcasting

### BACKGROUND

An access point serves as an interface between a wired network connection and computing devices having wireless capabilities. The access point thus allows distribution of services provided by the wired network to multiple computing devices simultaneously.

### BRIEF DESCRIPTION OF DRAWINGS

FIG. 1 illustrates a server, in accordance with an example of the present subject matter,

FIG. 2 illustrates a computing device, in accordance with an example of the present subject matter,

FIG. 3 illustrates a computing device, in accordance with another example of the present subject matter,

FIG. 4 illustrates a method of identifying access point information, in accordance with an example of the present subject matter,

FIG. 5 illustrates a method of identifying access point information, in accordance with another example of the present subject matter, and

FIG. 6 illustrates a method of identifying access point information, in accordance with another example of the present subject matter.

### DETAILED DESCRIPTION

A computing device, such as a smartphone or a laptop with wireless communication capabilities, detects various access points through an embedded radio module. The information related to the access points, detected by the radio module, is then displayed to a user through a user interface of the computing device. The information generally includes Service Set Identifier (SSID), signal strength, and encryption status of the access points.

Generally, a user may wish to obtain additional information related to the access points before establishing a connection. For instance, the user may wish to connect to an access point with high bandwidth availability, to attend a video conference. In such a situation, the user may have to connect and check the available bandwidth of different access points, one after another, until an access point with sufficient bandwidth is identified. Similarly, an access point may allow a predetermined number of users to connect and avail the services provided therein. In such situations, the user may not be able to connect to the access point if the predetermined number of users are already connected to the access point. Thus, the user may have to repeatedly try and connect to the access point until a connection is established. Therefore, availability of limited information related to detected access points makes the process of establishing a connection with the access points tedious and degrades the overall user experience.

According to an example implementation of the present subject matter, techniques for identifying additional information related to access points are disclosed.

According to an example the present subject matter, an information associated with the access point (AP) may be used to generate a unique ID corresponding to the AP. The unique ID may then be broadcasted along with a Service Set Identifier (SSID) of the AP for identification of information corresponding to the AP.

In an example, the information associated with the AP may be received from a user. The information may be received corresponding to AP parameters (APP), where the APP may include parameters defining the operational aspects of the AP. The APP may include different parameters including, but not limited to, title of the AP, AP owner name, AP owner address, available bandwidth, number of connected users, and AP type. A unique ID corresponding to the AP may be generated, where the unique ID may be associated with the APP. An AP information ID (APID) may be generated by combining the unique ID with a SSID of the AP. The APID may then be provided to the AP where the APID may be used for broadcasting.

Upon receiving the APID, the SSID may be replaced with the APID for broadcasting. In operation, when any computing device may scan for APs within its communicative range to identify APs available for connection, the APIDs associated with the APs may be displayed. Based on the APID, the computing device may identify the information associated with the AP and may provide the information to the user.

The APID thus allows the computing device to fetch and display information related to the Aps, without establishing a connection with the AP. The additional information related to the APs allows the user to select an access point based on the type of services offered therein. The additional information thus allows the user to conveniently select an access point from the access points leading to an enhancement in the overall user experience.

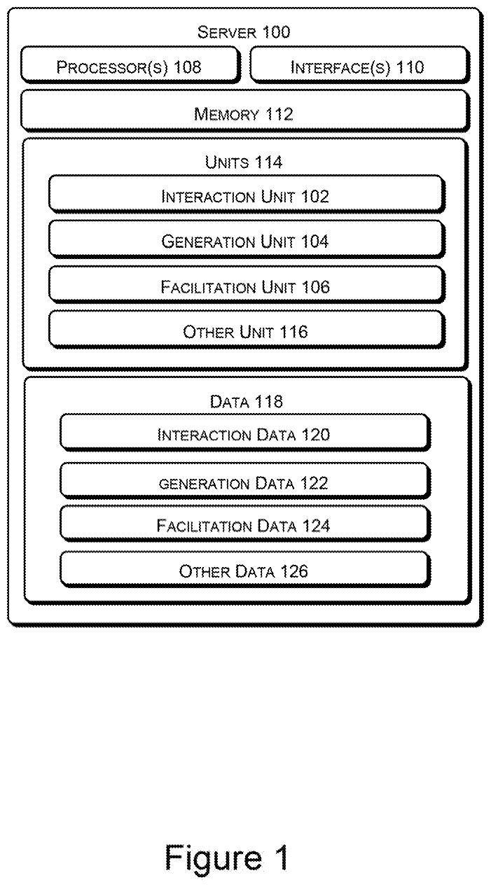

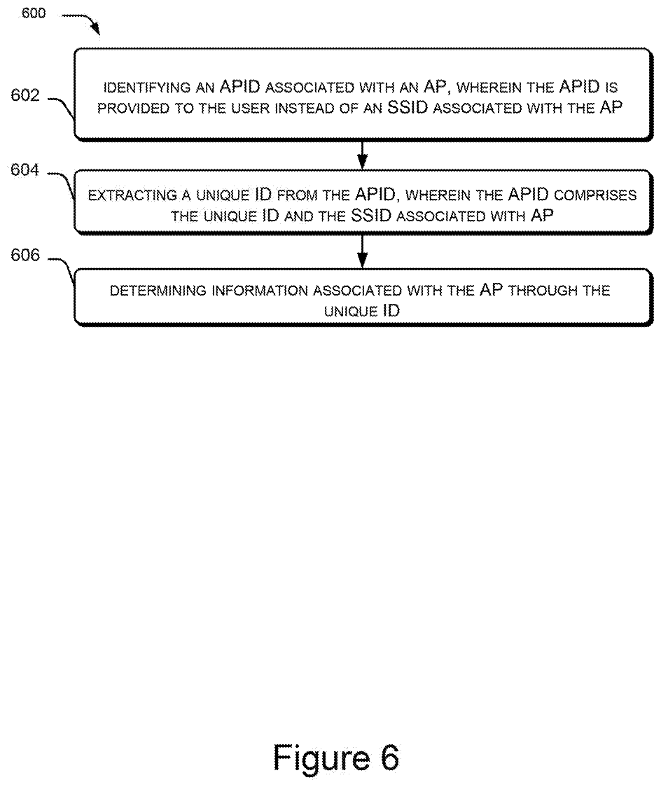

The above techniques are further described with reference to FIG. 1 to FIG. 6. It should be noted that the description and the figures merely illustrate the principles of the present subject matter along with examples described herein, and should not be construed as a limitation to the present subject matter. It is, thus understood that various arrangements may be devised that although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates a server 100, in accordance with an example implementation of the present subject matter. The server 100 may comprise processor(s) 108, interface(s) 110 coupled to the processor(s) 108, a memory 112, units 114, and data 118.

The functions of the various elements shown in the Figures, including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, conventional and/or custom, may also be included.

Further, the memory 112 may include any computer-readable medium including, for example, volatile memory (e.g., RAM), and/or non-volatile memory (e.g., EPROM, flash memory, etc.). The interface(s) 110 may include a variety of programmed or hardware interfaces that enable a user to communicate with the server 100.

The units 114 may include an interaction unit 102, a generation unit 104, a facilitation unit 106, and other units 116, in an example, the units 114 may reside in the memory 112. In another example, the units 114 may be implemented as separate hardware capable of performing different functionalities of the server 100. The units 114 may include routines, programs, objects, components, data structures, and the like, which perform particular tasks or implement particular abstract data types. The units 114 may further include electronic circuitry or a combination of electronic circuitry and control programs that operate the components according to the functions described herein. In an example, the other units 114 may perform functionalities that supplement other functions of the server 100.

The data 118 serves, amongst other things, as a repository for storing data that may be fetched, processed, received, or generated by the units 114. In an example, the data may include interaction data 120, generation data 122, facilitation data 124, and other data 126. The interaction data 120 may include information associated with the access points (APs) received from the user. Further, the generation data 122 may include unique IDs corresponding to APs. Moreover, the facilitation data 124 may include the Service Set Identifier (SSID) of the APs.

In an example, the interaction unit 102 may receive information associated with an AP from a user. The interaction unit 102 may receive the information in the form of AP Parameters (APP). The APP may include parameters such as, a bandwidth supported by the AP, a limitation on a maximum number of users supported by the AP and a communicative range of an AP, such that, the APP may define the operational aspects of the AP. The APP may further include parameters, such as title of the AP, AP owner name, AP owner address, and AP type.

The interaction unit 102 may receive the information associated with the AP via different modes. In an example, the interaction unit may provide a web form to the user to provide the information associated with the AP. An administrator or owner of the AP may utilize the web form to provide the information. In an example of the present subject matter, the interaction unit 102 may store the information associated with the AP, received from the user, in the interaction data 120.

The generation unit 104 may access the information stored in the interaction data 120. The generation unit 104 may utilize the information to generate a unique ID corresponding to the AP. The unique ID may be generated based on the APP. In an example, the unique ID may be a shortened unique reference link (URL) that may provide a link to the information associated with the AP. The generated unique ID may be stored in the generation data 122.

The facilitation unit 106 may access the unique ID corresponding to the AP from the generation data 122 and may combine the unique ID with the SSID of the AP to generate an AP information ID (APID). The unique ID may be combined with the SSID of the AP in various ways. In an example, the facilitation unit 106 may append the unique ID with the SSID, along with a keyword. The keyword may identify and differentiate the unique ID from SSID, in the APID. In another example, the facilitation unit 106 may append the SSID with the unique ID, along with a keyword. In an example, the facilitation unit 106 may store the APID in the facilitation data 124.

The facilitation unit 106 may access the APID from the facilitation data 124 and provide the APID to the AP for broadcasting.

Upon receiving the APID, the SSID may be replaced with the APID for broadcasting.

In an illustrative example, the information about an AP is first received from the user. The user may provide information associated with the AP, corresponding to different APPs. For instance, the information may correspond to a parameter title, such as ‘My Cafe AP’ and an Owner name, such as ‘My Cafe Beverages’. The information may further be provided by the user for other APPs, such as AP Type and password hint. Information corresponding to AP type may be include one of ‘Private’ or ‘Pay by Usage’ or ‘Free to guest’ and the password hint may include information such as ‘You may see the password on the counter’. The information may also correspond to available bandwidth, such as, 10 GBPS/20 GBPS, and limitation on number of users, if any, such as, 8 or 16 users.

Once the information is received, the unique ID corresponding to the AP, based on the information is generated. For instance, for a set of information having title of the AP as ‘My cafe AP’, owner name as ‘My Café Beverages’, AP type as ‘Free to Guests’, password hint as ‘You may find the password on the counter’, bandwidth as ‘10 GBPS’ and the limitation on number of users to 50, a unique ID ‘eYyTvo’ is generated.

Thereafter, an APID is generated by combining the unique ID with the SSID of the AP, along with a keyword. For instance, if the SSID of the AP is ‘My Cafe AP’, an APID, such as “My Cafe AP EID: eYyTvo” is generated. In another example, the APID is generated by appending the SSID of the AP with unique ID, along with the keyword. For instance, an APID, such as ‘eYyTvo EID: My Cafe AP’ may be generated. The APID ‘My Cafe AP EID: eYyTvo’ or ‘eYyTvo EID: My Cafe AP’ is provided to the AP for broadcasting. The AP on reception of the APID ‘My Cafe AP EID: eYyTvo’ replaces the SSID ‘My cafe AP’ with the APID ‘My Cafe AP EID: eYyTvo’ for identification of the AP.

When a computing device (not shown) scans within its communicative range to identify the various APs available for connection, the APIDs associated with the APs may be displayed. If a user of a computing device wishes to identify the information associated with an AP, (s)he may select an AP out of the multiple APs being displayed on the computing device. In response to user input, the computing device may send a request to the server 100 to provide the information associated with the AP. The request to provide the information associated with the AP may be received by the interaction unit 102. In response to the request from the computing device, the facilitation unit 106 may retrieve information associated with the AP and provide the information to the computing device.

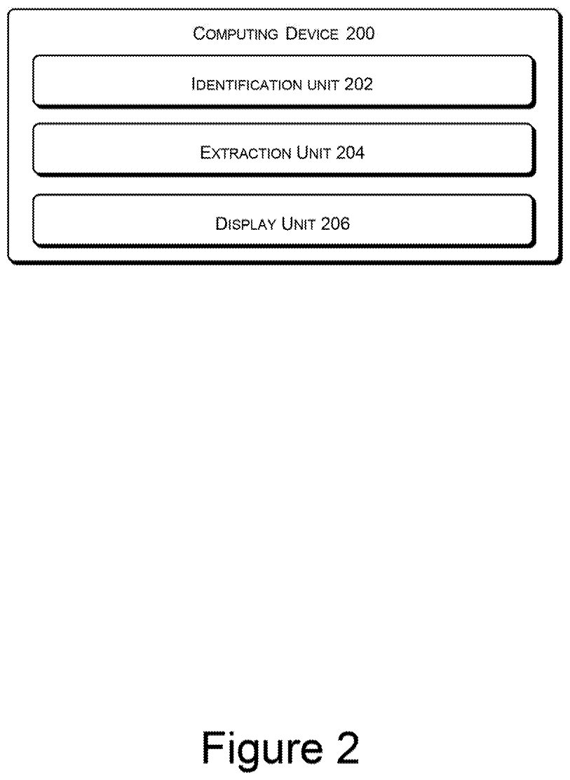

FIG. 2 illustrates a computing device 200, in accordance with an example implementation of the present subject matter. The computing device 200 may comprise an identification unit 202, an extraction unit 204, and a display unit 206. Examples of the computing device 200 may include, but not limited to, smartphones, laptops, desktops, PDAs, and tablets.

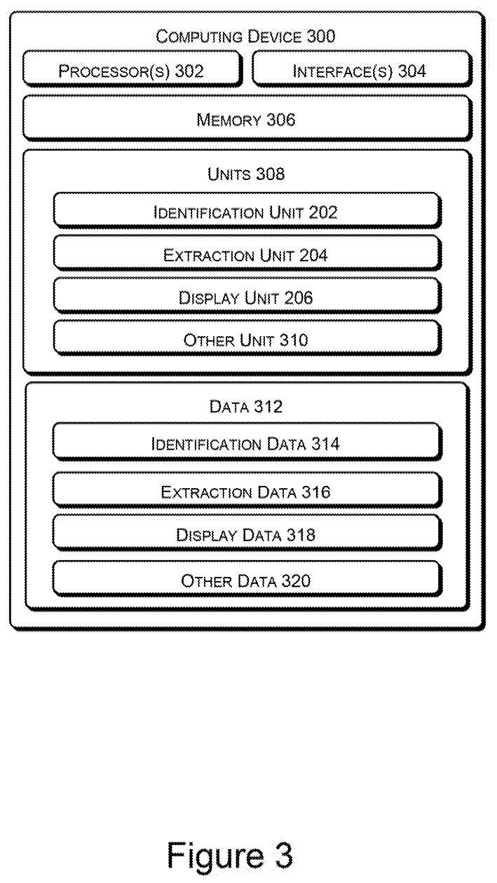

In an example, the identification unit 202 may identify a list of APs available for connection. The identification unit 202 may identify an APID associated with an AP. Further, the extraction unit 204 may extract a unique ID from the APID, where the unique ID may be associated with the APP. The APP may include, but not limited to, title of the AP, AP owner name, AP owner address, available bandwidth, number of connected users, and AP type. The extraction unit 204 may determine the information associated with the AP through the unique ID. The display unit 206 may display the information to a user. The detailed working of the computing device 200 is further explained with reference to FIG. 3.

FIG. 3 illustrates a computing device 300, in accordance with an example implementation of the present subject matter. The computing device 300 includes processor(s) 302, interface(s) 304 coupled to the processor(s) 302, memory 306, units 308 and data 312.

The functions of the various elements shown in the Figures, including the “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network, processor, application specific integrated circuit (ASIC), field programmable gate array (FPGA), read only memory (ROM) for storing instructions, random access memory (RAM), non-volatile storage. Other hardware, conventional and/or custom, may also be included.

Further, the memory 306 may include any computer-readable medium including, for example, volatile memory (e.g., RAM), and/or non-volatile memory (e.g., EPROM, flash memory, etc.). The interface(s) 304 may include a variety of programmed or hardware interfaces that enable the user to communicate with the computing device 300.

The units 310 may comprise identification unit 202, the extraction unit 204, the display unit 206, and other units 310. In an example, the units 308 may reside in the memory 306. In another example, the units 308 may be implemented as separate hardware capable of performing different functionalities of the computing device 300. The units 308 may include routines, programs, objects, components, data structures, and the like, which perform particular tasks or implement particular abstract data types. The units 308 may further include electronic circuitry or a combination of electronic circuitry and control programs that operate the components according to the functions described herein. In an example, the other units 310 may perform functionalities that supplement other functions of the computing device 300.

The data 312 serves, amongst other things, as a repository for storing data that may be fetched, processed, received, or generated by the units 308. In an example, the data may include identification data 314, extraction data 316, display data 318, and other data 320. The identification data 314 may include access point information ID (APID) corresponding to access points (APs). Further, the extraction data 316 may include unique IDs corresponding to APIDs of the APs respectively. Moreover, the display data 313 may include information about APs determined by the extraction unit 204.

In an example, the computing device 300 may first detect an AP available in a communicative range of the computing device 300. It would be noted that the communicative range of the computing device 300 is the area in which the computing device 300 may scan for available APs and obtain information about any AP present therein.

In an example of the present subject matter, the APs may broadcast an APID associated with them, instead of the SSID. The APID may be a combination of the SSID of the AP, along with a unique ID associated with the AP. Thus, the identification unit 202 of the computing device 300 may identify an APID corresponding to an AP detected by the computing device 300. The APID may be stored in the identification data 314. As described earlier, the APID may include a keyword that identifies the unique ID in the APID.

In an example of the present subject matter, the extraction unit 204 may access the identification data 314 and extract the unique ID corresponding to the APID. In an example, the extraction unit 204 may utilize the keyword to identify and extract the unique ID from the APID. In another example, the extraction unit 204 may identify the SSID using the keyword. In the example, the extraction unit 204 may determine information associated with the AP through the unique ID.

The unique ID may be a shortened URL or may represent a digital location from where information of the AP can be extracted. Thus, to determine the information associated with the AP through unique ID, the extraction unit 204 may utilize the unique ID. In case the unique ID is representative of a URL, the extraction unit may access the URL and determine the information associated with the AP.

For example, the extraction unit 204 may access the URL and download an information file associated corresponding to the AP. The extraction unit 204 may parse the information file to determine the information related to the AP. The extraction unit 204 may also store the information included in the information file in the display data 318.

In an example, the display unit 206 may access the information stored in the display data 318 and display the information to the user. In an example, the information may be provided to the user when the user hovers a pointer over the AP icon displayed on a graphical user interface, such as interface 304 of the computing device 300. In another example, the information may be provided to the user when the user selects an icon corresponding to the AP displayed on the interface 304.

The units 308 may further determine the information associated with the APs present in the detection range of the computing device 300 and may categorize the APs based on the determined information. In one example, the icons of the APs having same encryption type may be combined and be represented in similar colours. For instance, the icons of the free APs may be combined and represented in green colour while the icons of the paid APs may be combined and represented in red colour. Although the categorization of the APs has been described based on the encryption type of the APs, it may be noted that the APs may also be categorized based on other parameters.

In an example implementation, an AP with an APO, such as ‘My Cafe AP EID: eYyTvo’ is detected, A unique ID from the APID is identified using the keyword ‘EID’. In the present instance, the identified unique ID is identified to be ‘eYyTvo’. The unique ID ‘eYyTvo’ may be a shortened URL and maybe used to access a digital location. In an example, the digital location point to the server 100 to fetch information corresponding to the APID. Further, an information file from the URL is downloaded and parsed to determine the information related to the AP. In an example of the present subject matter, the determined information is displayed to the user.

In another example, the manner in which the SSID and the unique ID are combined to form the APID may vary, such that an AP may have an APID ‘eYyTvo EID: My Cafe AP’. In such examples, the computing device 300 may determine the SSID and the SSID based on the keyword, such as ‘EID’. Therefore, the APID ‘eYyTvo EID: My Cafe AP’ may be analysed by the computing device 300 to identify and extract the unique ID as ‘eYyTvo’. Thus, based on the APID, the computing device 300 may identify a unique ID associated with the AP, and fetch information associated with the AP.

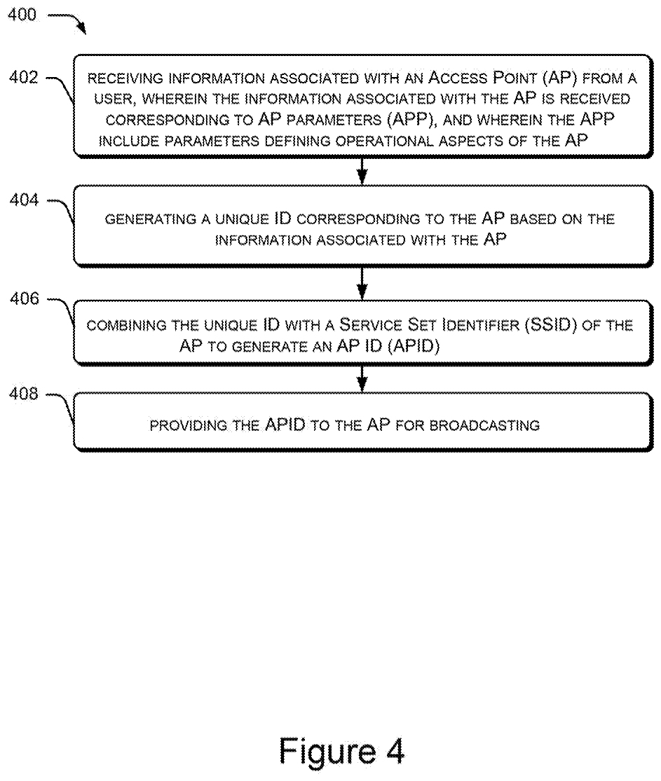

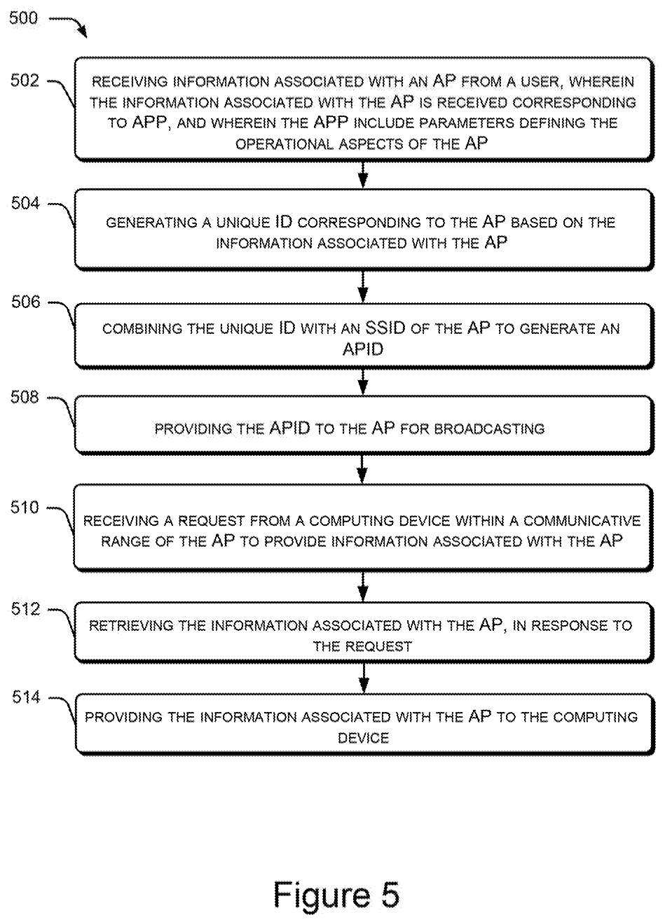

FIG. 4 and FIG. 5 respectively illustrates the methods 400 and 500 of identifying access point (AP) information, in accordance with example implementations of the present subject matter, Although the method 400 and 500 may be implemented in a variety of computing devices, but for the ease of explanation, the description of the exemplary methods 400 and 500 is provided in reference to the above-described server 100. The order in which the methods 400 and 500 are described is not intended to be construed as a limitation, and any number of the described method blocks may be combined in any order to implement the method 400, or an alternative method.

It may be understood that blocks of the methods 400 and 500 may be performed in the server 100. The blocks of the methods 400 and 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 402, information associated with an AP is received from a user. The information associated with the AP is received corresponding to different APPs. The APPs include parameters defining operational aspects of AP, such as, available bandwidth of the AP, a limitation on maximum number of users, and a communicative range of the AP, in an example the interaction unit 102 of the server 100 may receive the information from the user.

At block 404, a unique ID corresponding to the AP is generated based on the information associated with the AP. In an example, the generation unit 104 of the server 100, may generate the unique ID. The unique ID may be unique for an AP and may determine the information associated with the AP

At block 406, the unique ID is combined with the SSID of the AP to generate an AP information ID (APID). In an example the facilitation unit 106 of the server 100, may combine the unique ID with the SSID of the AP to generate the APID.

At block 408, the APID may be provided to the AP for broadcasting. In an example, the facilitation unit 106 may provide the APID for broadcasting and the AP may broadcast the APID instead of SSID for identification.

FIG. 5 illustrates a method 500 of identifying access point (AP) information, in accordance with another example implementation of the present subject matter.

At block 502, information associated with an AP is received from a user. The information associated with the AP is received corresponding to APP. The APP include parameters defining operational aspects of AP. In an example, an interaction unit, such as an interaction unit 102 of a server 100 may receive the information from the user.

At block 504, a unique ID corresponding to the AP is generated based on the information associated with the AP. In an example, a generation unit, such as a generation unit 104 of the server 100, may generate the unique ID. The unique ID may be generated corresponding to the APPs of the AP.

At block 506, the unique ID is combined with the SSID of the AP to generate an APID. In an example, a facilitation unit, such as the facilitation unit 106 of the server 100, may append the unique ID with the SSID of the AP to generate the APID.

At block 508, the APID may be provided to the AP for broadcasting. In an example, the facilitation unit 106 may provide the APID to AP, for broadcasting. In the present example, the AP may be identified by the computing devices using the APID broadcasted by the AP.

At block 510, a request to provide information associated with the AP is received from a computing device within the communicative range of the AP. In an example, the request may be received by the interaction unit 102.

At block 512, in response to request, the information associated with the AP is retrieved. In an example, the facilitation unit 106 may retrieve the information corresponding to the AP. The facilitation unit 106 may search the interaction data 120 of the server 100 to identify and retrieve the information corresponding to the AP.

At block 514, the information associated with the AP is provided to the computing device 300, In an example, the information associated with the AP may be provided by the facilitation unit 106.

It may be understood that blocks of the method 600 may be performed in the computing device 300. The blocks of the method 600 may be executed based on instructions stored in a non-transitory computer-readable medium; as will be readily understood. The non-transitory computer-readable medium may include, for example, digital memories, magnetic storage media, such as magnetic disks and magnetic tapes, hard drives, or optically readable digital data storage media.

At block 602, an access point information ID (APID) corresponding to an Access Point (AP) is identified. In an example, an identification unit, such as an identification unit 202 of a computing device 300, may identify the APID corresponding to the AP. The interaction unit 102 may scan within communicative range of the computing device 300 to detect and identify multiple APIDs corresponding to the APs.

At block 604, a unique ID is extracted from the APID, where the unique ID is associated with the AP Parameters (APP). In an example, an extraction unit, such as the extraction unit 204 of the computing device 300, may extract the unique ID from the APID. The extraction unit 204 may identify the unique ID in the APID using a keyword.

At block 606, the information of the AP is accessed through the unique ID. In an example, the extraction unit 204 may access the information of the AP through the unique ID.

Although implementations of the present subject matter have been described in language specific to methods and/or structural features, it is to be understood that the present subject matter is not limited to the specific methods or features described. Rather, the methods and specific features are disclosed and explained as example implementations of the present subject matter.

We claim:

1. A method for identifying information about an Access Point (AP), the method comprising:
receiving information associated with the AP from a user, wherein the information associated with the AP is received corresponding to AP Parameters (APP), and wherein the APP include parameters defining operational aspects of the AP;
generating a unique ID corresponding to the AP based on the information associated with the AP;
combining the unique ID with a Service Set Identifier (SSID) of the AP to generate an AP Information ID (APID); and
providing the APID to the AP for broadcasting.

2. The method as claimed in claim 1, wherein the unique ID is a shortened unique reference link (URL), providing a link to the information associated with the AP.

3. The method as claimed in claim 1, wherein the unique ID is combined with the SSID using a keyword.

4. The method as claimed in claim 1, wherein the APID is accessible to the users connecting to the AP, and wherein the user accesses information associated with the AP through the APID.

5. The method as claimed in claim 1, wherein the APP include at least one of AP password information, AP charges, AP bandwidth, and AP type.

6. The method as claimed in claim 1 further comprising:
receiving a request from a computing device within a communicative range of the AP to provide the information associated with the AP;
retrieving the information associated with the AP, in response to the request; and
providing the information associated with the AP to the computing device.

7. The method as claimed in claim 6, wherein the request is received from the computing device through the unique ID associated with the APID.

8. The method as claimed in claim 6, wherein the information associated with the AP is provided to an extraction unit of the computing device.

9. A method for identifying information about an AP, the method comprising:
identifying an APID associated with an AP, wherein the APED is provided to a user instead of an SSID associated with the AP;
extracting a unique ID from the APID, wherein the APID comprises the unique ID and the SSID associated with the AP; and
determining information associated with the AP through the unique ID.

10. The method as claimed in claim 9, wherein determining the information associated with the AP comprises:
identifying an URL based on the unique ID; and
fetching the information associated with the AP from the URL.

11. The method as claimed in claim 10 further comprising displaying the information associated with the AP to a user.

12. The method as claimed in claim 11, wherein displaying the information associated with the AP comprises displaying the AP in a predefined color based on at least one APP.

13. A device comprising:
an identification unit to identify an APID corresponding to an AP;
an extraction unit coupled to the identification unit to:
extract a unique ID from the APID, wherein the unique ID is associated with APP; and
determine information associated with the AP through the unique ID; and
a display unit coupled to the extraction unit to display the information associated with the AP to a user.

14. The device as claimed in claim 13, wherein the extraction unit utilizes a keyword to extract the unique ID from the APID.

15. The device as claimed in claim 13, wherein the extraction unit downloads and parses a web file based on the unique ID to determine the information associated with the AP.
